(19) United States
(12) Patent Application Publication
(10) Pub. No.: US 2012/0186413 A1
(43) Pub. Date: Jul. 26, 2012

(54) TOOL ATTACHMENT FOR REMOVAL OF WINDOW GLAZING

(76) Inventor: Robert C. Schroeder, Montgomery, AL (US)

(21) Appl. No.: 13/011,152

(22) Filed: Jan. 21, 2011

(51) Int. Cl. B26D 1/00

(52) U.S. Cl. 83/697

(57) ABSTRACT

A tool attachment for use with a power tool to facilitate the removal of window glazing compound may include a proximal coupling portion configured to be attached to a power tool, a distal material removal portion, and a generally planar blade portion intermediate the coupling portion and the material removal portion. The material removal portion projects outwardly from the plane of the blade portion and has a distal working end with a plurality of teeth for grinding away glazing compound during use. In another embodiment, a tool attachment may include a planar coupling portion and at least one material removal portion projecting outwardly from the plane of the coupling portion.

### TECHNICAL FIELD

The present invention relates generally to hand tools, and more particularly to a tool attachment for removing window glazing compound from a window.

### BACKGROUND

The repair and/or replacement of window panes requires the removal of putty, or window glazing compound, that secures the glass pane within a window frame. Conventional tools and methods for removing glazing compound from a window are time consuming and oftentimes cause damage or breakage of the glass panes, window frame, and/or muntins. A need exists for a tool that facilitates quick and easy removal of window glazing compound without damaging glass panes.

### SUMMARY

The present invention overcomes the foregoing and other shortcomings and drawbacks of tools and methods heretofore known for removing window glazing compound from window assemblies. While the invention will be described in connection with certain embodiments, it will be understood that the invention is not limited to these embodiments. On the contrary, the invention includes all alternatives, modifications and equivalents as may be included within the spirit and scope of the present invention.

In one embodiment, a tool attachment for use with a power tool to facilitate the removal of window glazing compound may include a proximal coupling portion configured to be attached to a power tool, a distal material removal portion, and a generally planar blade portion intermediate the coupling portion and the material removal portion. The material removal portion projects outwardly from the plane of the blade portion and has a distal working end with a plurality of teeth for grinding away glazing compound during use. The blade portion may also include tapered cutting edges to facilitate the removal of glazing compound during use.

In another embodiment, a tool attachment may include a planar coupling portion and at least one material removal portion projecting outwardly from the plane of the coupling portion. In one aspect, two material removal portions may be provided, each one positioned on a respective side of the coupling portion. Each material removal portion and has a distal working end with a plurality of teeth for grinding away glazing compound during use.

The above and other objects and advantages of the present invention shall be made apparent from the accompanying drawings and the description thereof.

### DESCRIPTION OF FIGURES

FIG. 1 is a perspective view of an exemplary tool attachment for use with a power tool to facilitate the removal of window glazing compound, in accordance with the principles of the present invention.

FIG. 2 is a front view of the tool attachment of FIG. 1.

FIG. 2A is an end view of the tool attachment of FIG. 1, as viewed along line 2A-2A of FIG. 2.

FIG. 2B is an end view of the tool attachment of FIG. 1, as viewed along line 2B-2B of FIG. 2.

FIG. 3 illustrates use of the tool attachment of FIG. 1 to remove window glazing compound.

FIG. 4 is a cross-sectional view taken along line 4-4 of FIG. 3.

FIG. 5 is a perspective view of a second exemplary embodiment of a tool attachment in accordance with the principles of the present invention.

FIG. 6 is a side view of the embodiment of FIG. 5.

FIG. 7 is a perspective view of a third exemplary embodiment of a tool attachment in accordance with the principles of the present invention.

FIG. 8 is an end view of the tool attachment of FIG. 7.

FIG. 9 is a perspective view of a fourth exemplary embodiment of a tool attachment in accordance with the principles of the present invention.

### DETAILED DESCRIPTION

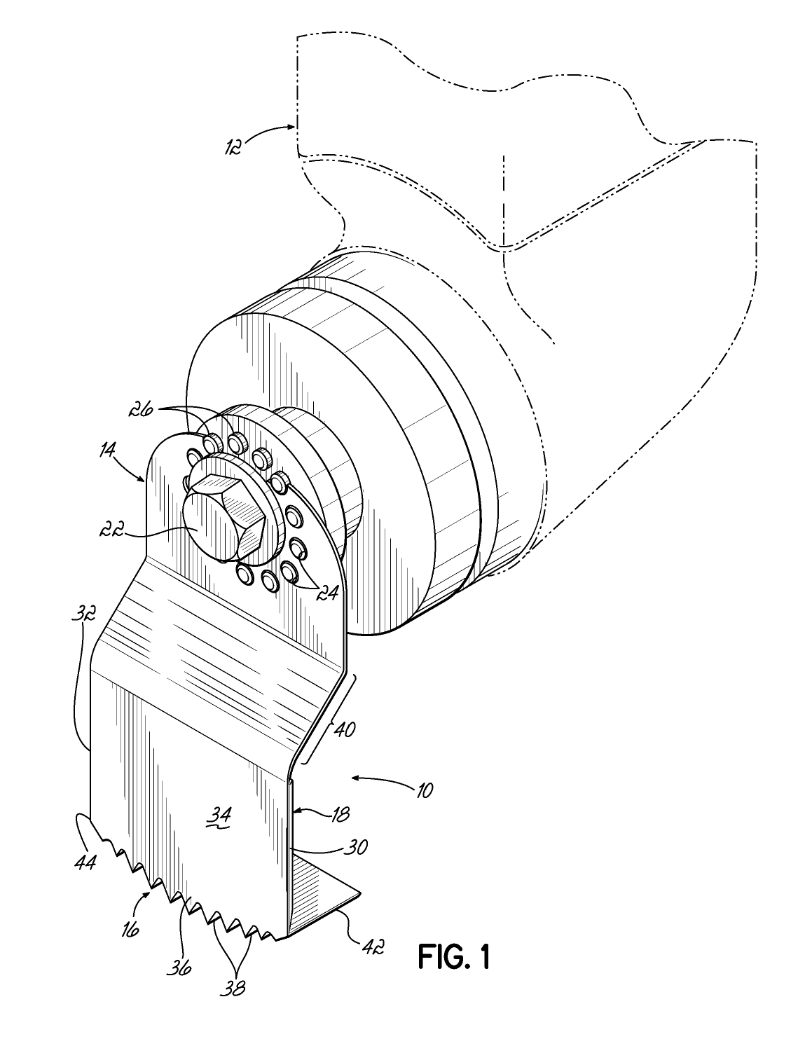

FIG. 1 depicts an exemplary tool attachment 10 for use in removing window glazing compound from a window assembly and which is configured to be operatively coupled to a power tool 12, such as a Dremel® Multi-Max™ oscillating tool sold by Robert Bosch Tool Corporation of Mount Prospect, Ill. While the embodiment shown and described herein is configured for use with a Multi-Max™ oscillating tool, it will be appreciated that various other power tools may alternatively be used.

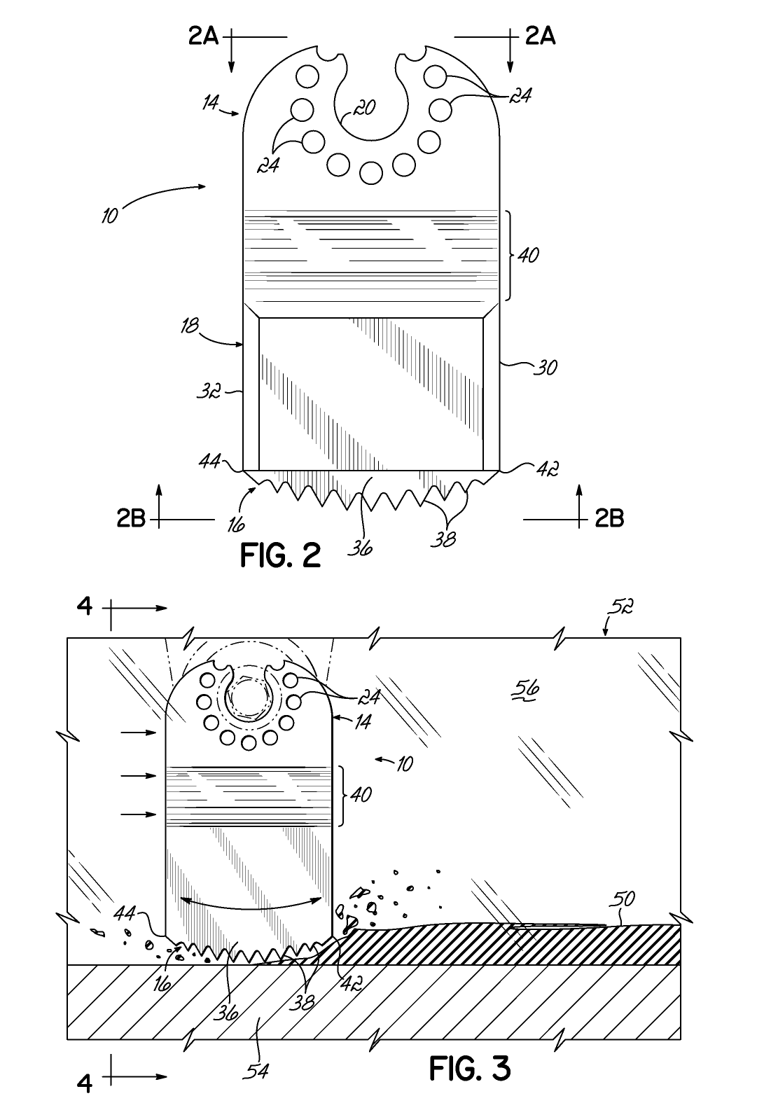

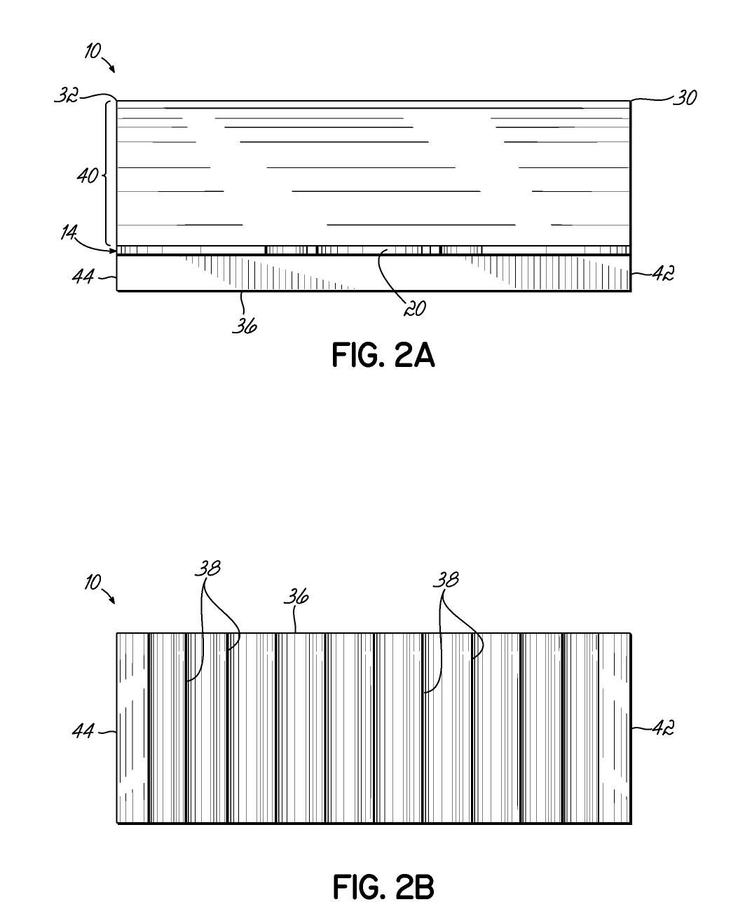

The tool attachment 10 comprises a proximal coupling portion 14 configured to be attached to the power tool 12, a distal material removal portion 16, and a planar blade portion 18 intermediate the coupling portion 14 and the material removal portion 16. With continued reference to FIG. 1, and referring further to FIGS. 2-4, the proximal coupling portion 14 of the embodiment shown includes an open central aperture 20 having an arcuate shape configured to receive a threaded fastener 22 for securing the tool attachment to power tool 12. A plurality of circular apertures 24 having diameters that are relatively smaller than the diameter of the central aperture 20 are spaced circumferentially around the central aperture 20 and are positioned and arranged to engage corresponding protrusions 26 on the attachment portion of the power tool 12. While the coupling portion 14 shown and described herein includes apertures 20, 24 particularly configured and arranged to mate with the attachment features on a Dremel® Multi-Max™ oscillating tool, it will be appreciated that modification of the features of the coupling portion 14 may be required to facilitate coupling the tool attachment 10 to various other power tools with which a tool attachment in accordance with the principles of the present invention may be used.

The blade portion 18 of the tool attachment 10 includes first and second oppositely disposed side edges 30, 32. In one embodiment, the side edges 30, 32 are tapered to define cutting edges that may be used to cut into the window glazing compound during use of the tool attachment 10 to facilitate removal of the glazing compound. In another embodiment, a back surface 34 of the blade portion 18, which may be pressed against a glass pane during use of the tool attachment 10, may be provided with a smooth finish suitable to prevent scratching of the glass pane.

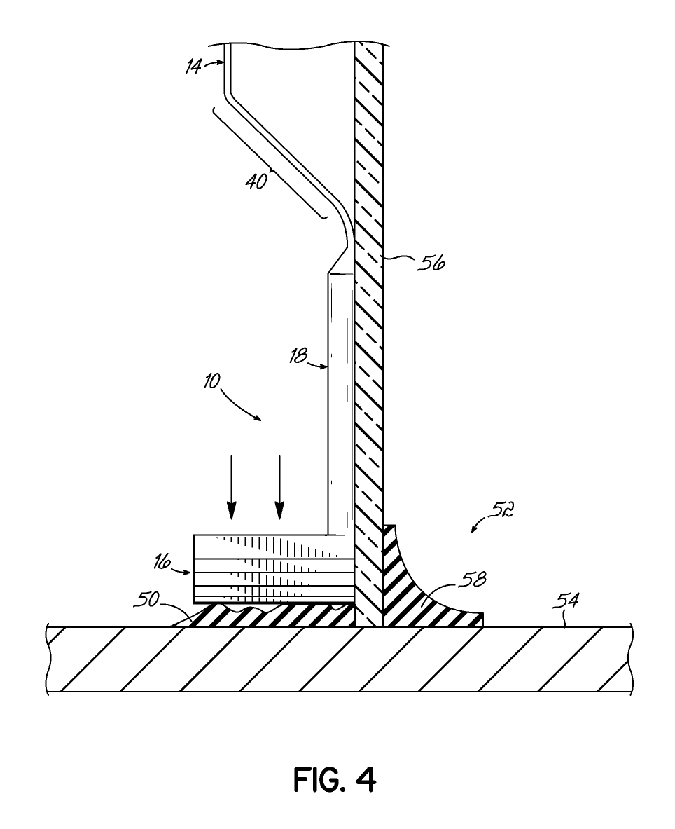

The distal material removal portion 16 of the tool attachment 10 projects generally outwardly from the plane of the blade portion 18 and has a generally arcuate distal working end 36 including a plurality of teeth 38. The teeth 38 extend out of the plane of the blade portion 18, and apices of the teeth 38 are spaced apart between the first and second side edges 30, 32 of the blade portion 18. As depicted in FIGS. 1 and 4, the proximal coupling portion 14 of the tool attachment 10 is offset from the blade portion 18 of the tool attachment 10, generally in the same direction that the material removal portion 16 projects from the blade portion 18, to facilitate proper engagement of the blade portion 18 against a pane of glass during use of the tool attachment 10. In the embodiment shown, an angled portion 40 extends at an acute angle relative to the plane of the blade portion 18 to provide the offset between the coupling portion 14 and the blade portion 18.

In an exemplary embodiment, the material removal portion 16 further comprises first and second oppositely disposed lateral edges 42, 44, each positioned proximate a respective one of the first and second side edges 30, 32 of the blade portion 18. The first and second lateral edges 42, 44 of the material removal 16 portion may be tapered to define cutting edges that further facilitate the removal of glazing compound from a window frame.

In the embodiment shown, the tool attachment 10 comprises metal material and may be formed by suitable manufacturing processes, such as stamping, forging, casting, machining, or various other manufacturing processes. It will be appreciated, however, that the tool attachment may alternatively be made from various other materials suitable for use in removing window glazing compound. In one non-limiting embodiment, for example, the tool attachment 10 may be made from ceramic material.

FIGS. 3-4 illustrate use of the tool attachment 10 of FIG. 1 during removal of window glazing compound 50 from a window assembly 52. In use, the tool attachment 10 is coupled to a power tool 12 by engaging and securing the coupling portion 14 to the corresponding attachment features on the power tool 12. The material removal portion 16 is placed in contact with the glazing compound 50 on the window assembly 52, and the power tool 12 is actuated. The user then moves the tool attachment 10 with a back-and-forth motion along the glazing compound 50 deposited on the window frame 54 and the glass pane 56, whereby the tapered cutting edges 30, 32, 42, 44 of the blade portion 18 and the material removal portion 16 may cut into the glazing compound 50, while the teeth 38 on the material removal portion 16 grinds and smoothes away the glazing compound 50. As illustrated in FIG. 3, the power tool 12 may oscillate the tool attachment 10 in a slight arc, such as about +/−3 degrees about the attachment fastener 22, while the user moves the power tool 12 and tool attachment 10 along the window frame 54. The tool attachment 10 thereby facilitates quick and easy removal of glazing compound 50 and greatly reduces the time and effort required to remove glazing compound 50 while providing a clean finish without damaging the glass pane 56. Moreover, use of the tool attachment 10 to remove glazing compound 50 also eliminates or minimizes gouging and splintering of the window frame 56 and muntins 58.

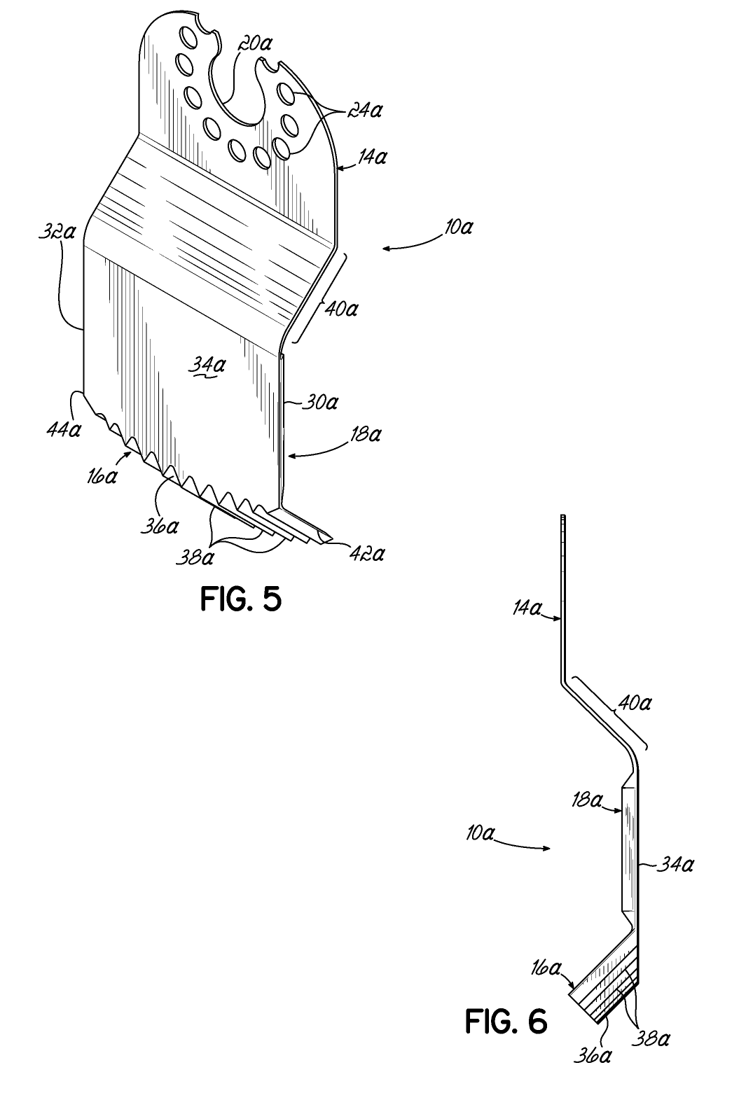

In the embodiments depicted in FIGS. 1-4, the material removal portion projects 16 outwardly from the plane of the blade portion 18 and along a direction generally perpendicular to the plane of the blade portion 18. FIGS. 5 and 6 depict an alternative embodiment of a tool attachment 10a in accordance with the principles of the present invention. This embodiment is generally similar to the embodiment depicted in FIGS. 1-4, however, the material removal portion 16a projects outwardly from the plane of the blade portion 18a of the tool attachment 10a along a direction that forms an acute angle with the plane of the blade portion 18a. This embodiment may be useful for removing glazing compound from tight spaces, or when it is desired to remove excess glazing compound and provide a clean finish, without completely removing the window glazing compound. Various other features of this embodiment are similar to the features shown and described with respect to the exemplary tool attachment 10 depicted in FIGS. 1-4, and similar reference numerals are used to reference the similar features.

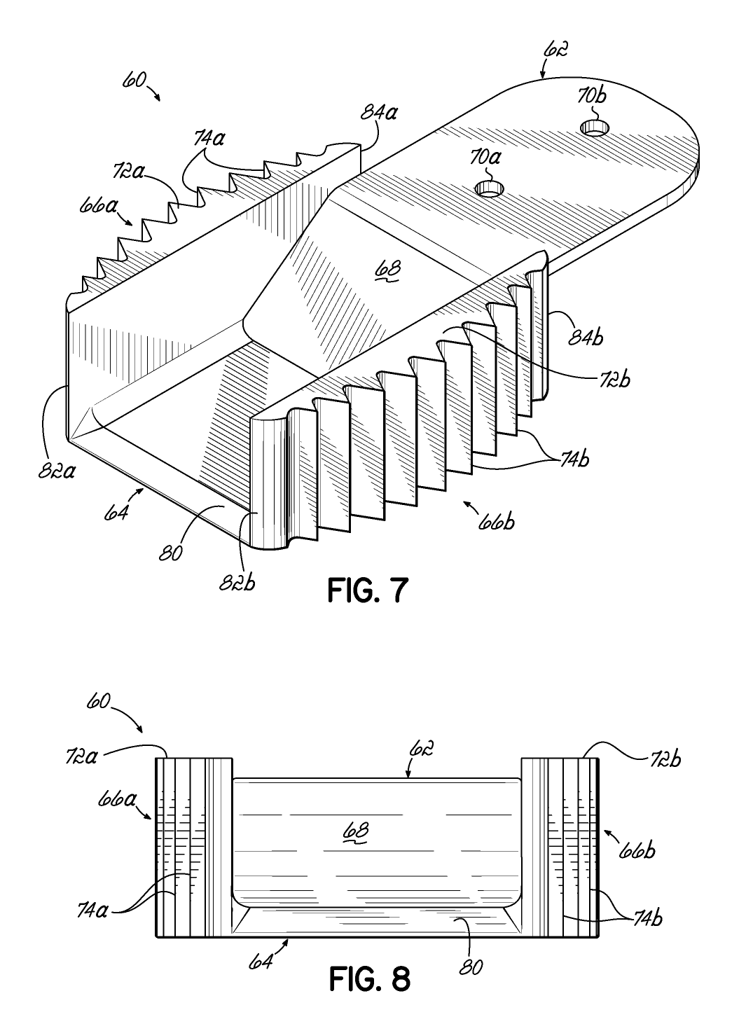

FIGS. 7 and 8 depict yet another exemplary embodiment of a tool attachment 60 for removing window glazing compound and which may be used with a power tool (not shown) configured to impart reciprocating movement to the tool attachment 60. In this embodiment, the tool attachment 60 comprises a generally planar coupling portion 62 configured to be attached to a power tool, a generally planar blade portion 64, and first and second spaced-apart material removal portions 66a, 66b disposed on opposite sides of the coupling portion 62 and the blade portion 64. The coupling portion 62 is offset from the blade portion 64 by an angled portion 68, and includes a pair of apertures 70a, 70b to facilitate securing the tool attachment 60 to the power tool with suitable fasteners (not shown).

While a pair of apertures 70a, 70b are shown and described in this embodiment for securing the tool attachment 60 to a power tool, it will be appreciated that the coupling portion 62 may alternatively include various other features for securing the tool attachment 60 to a power tool. It will also be appreciated that the tool attachment 60 may alternatively be provided with a single material removal portion, as may be desired, instead of two material removal portions 66a, 66b as shown and described herein.

The first and second material removal portions 66a, 66b extend generally outwardly from the plane of the blade portion 64 and from the plane of the coupling portion 62. Each material removal portion 66a, 66b includes an outwardly-facing, distal working end 72a, 72b with plural teeth 74a, 74b for grinding and smoothing glazing compound, similar to the material removal portion 16 of the tool attachment 10 shown and described with reference to FIG. 1. The blade portion 64 includes first and second oppositely disposed side edges 80 (only one shown), and apices of the teeth 74a, 74b of the material removal portions 66a, 66b are spaced apart between the first and second side edges 80, in a manner similar to the material removal portion 16 of the tool attachment 10 shown and described with reference to FIG. 1.

One or both of the first and second side edges 80 of the blade portion 64 may be tapered to define cutting edges that may be used to cut into window glazing compound during use of the tool attachment 60. Likewise, each of the material removal portions 66a, 66b may include tapered cutting edges 82a, 82b, 84a, 84b proximate the first and second side edges 80 of the blade portion 64, respectively, to facilitate removal of glazing compound.

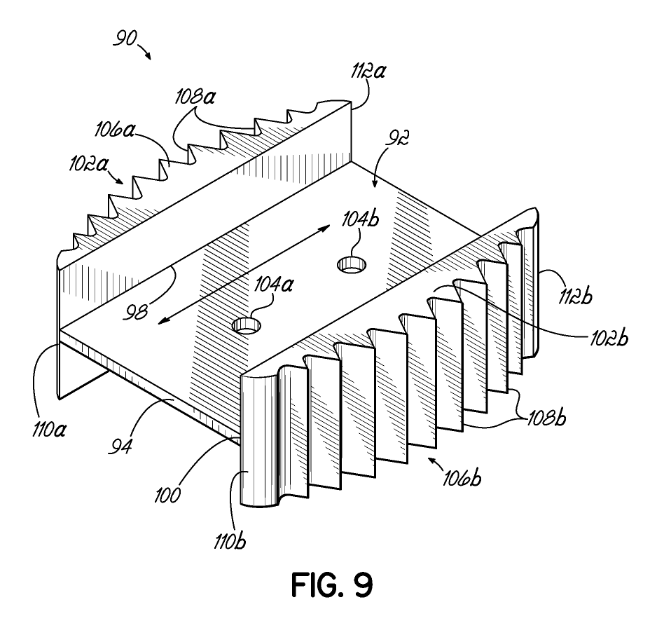

FIG. 9 depicts yet another exemplary tool attachment 90 in accordance with the principles of the present invention and which may also be used with a power tool (not shown) configured to impart reciprocating movement to the tool attachment 90. In this embodiment, the tool attachment 90 includes a planar coupling portion 92 having first and second oppositely disposed distal ends 94, 96 and first and second oppositely disposed lateral sides 98, 100. First and second material removal portions 102a, 102b are disposed on opposite sides of the coupling portion 92, adjacent the respective first and second lateral sides 98, 100. In the embodiment shown, the coupling portion 92 is positioned approximately midway along the heights of the respective material removal portions 102a, 102b and includes apertures 104a, 104b to facilitate securing the tool attachment 90 to corresponding attachment features of the power tool with suitable fasteners (not shown). It will be appreciated, however, that the coupling portion 92 may alternatively be positioned at various other locations relative to the material removal portions 102a, 102b, and may include various other features for securing the tool attachment 90 to a power tool.

With continued reference to FIG. 9, the material removal portions 102a, 102b project in directions generally outwardly from the plane of the coupling portion 92 and are similar in configuration to the material removal portions 66a, 66b shown and described above with reference to FIGS. 7 and 8. Specifically, each material removal portion 102a, 102b includes an outwardly-facing, distal working end 106a, 106b with plural teeth 108a, 108b for grinding and smoothing glazing compound. Apices of the teeth 108a, 108b of the material removal portions 102a, 102b are spaced apart between the first and second distal ends 94, 96 of the coupling portion 92. Each of the material removal portions 102a, 102b may further include tapered cutting edges 110a, 110b, 112a, 112b proximate the first and second distal ends 94, 96 of the coupling portion 92, respectively, to facilitate removal of glazing compound.

In use, either of the exemplary tool attachments 60, 90 of FIGS. 7-9 may be secured to the corresponding attachment features of a power tool configured to impart reciprocating movement to the tool attachments 60, 90, whereafter the material engagement portions 66a, 66b, 102a, 102b may be placed in contact with window glazing compound on a window assembly. Actuation of the power tool causes the material removal portions 66a, 66b, 102a, 102b to move back and forth, while the user manually guides the tool attachment 60, 90 along the window frame to remove the window glazing compound in a manner similar to that described above with reference to FIGS. 3 and 4.

While various aspects in accordance with the principles of the invention have been illustrated by the description of various embodiments, and while the embodiments have been described in considerable detail, they are not intended to restrict or in any way limit the scope of the invention to such detail. The various features of the exemplary tool attachment embodiments shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope of the general inventive concept.

What is claimed is:

1. A tool attachment for power tools that facilitates removal of window glazing compound, the attachment comprising:
a proximal coupling portion configured to be attached to a power tool;
a distal material removal portion; and
a planar blade portion intermediate said coupling portion and said material removal portion;
said blade portion having first and second oppositely disposed side edges;
said material removal portion projecting outwardly from the plane of said cutting blade portion and having an arcuate distal working end including a plurality of teeth, said teeth extending out of the plane of said blade portion and having apices spaced apart between said first and second side edges.

2. The tool attachment of claim 1, wherein at least one of said first and second side edges defines a tapered cutting edge.

3. The tool attachment of claim 1, wherein said coupling portion is offset from the plane of said blade portion.

4. The tool attachment of claim 1, wherein said material removal portion projects outwardly from the plane of said blade portion along a direction substantially perpendicular to the plane of said blade portion.

5. The tool attachment of claim 1, wherein said material removal portion projects outwardly from the plane of said blade portion along a direction that forms an acute angle with the plane of said blade portion.

6. The tool attachment of claim 1, wherein said material removal portion comprises:
first and second oppositely disposed lateral edges, each positioned proximate a respective one of said first and second side edges of said blade portion;
said first and second lateral edges defining respective tapered cutting edges.

7. The tool attachment of claim 1, wherein said blade portion comprises a back surface located opposite the direction of said material removal portion, said back surface having a smooth finish suitable to prevent scratching a glass pane when said back surface contacts the glass pane during removal of window glazing compound.

8. A tool attachment for power tools that facilitates removal of window glazing compound, the attachment comprising:
a planar coupling portion configured to be attached to a power tool and having oppositely disposed first and second ends; and
at least one material removal portion projecting outwardly from the plane of said coupling portion;
said material removal portion having an arcuate distal working end including a plurality of teeth, said teeth extending out of the plane of said coupling portion and having apices spaced apart between said first and second ends of said coupling portion.

9. The tool attachment of claim 8, comprising first and second material removal portions spaced apart by said coupling portion.

10. The tool attachment of claim 9, further comprising a generally planar blade portion extending between said first and second material removal portions.

11. The tool attachment of claim 10, wherein said blade portion includes first and second oppositely disposed side edges, at least one of said first and second side edges defining a tapered cutting edge.
